(19) United States
(12) Patent Application Publication
(10) Pub. No.: US 2025/0100147 A1
(43) Pub. Date: Mar. 27, 2025

(54) ELECTRONIC EQUIPMENT ASSEMBLY APPARATUS

(71) Applicant: NACHI-FUJIKOSHI CORP., Tokyo (JP)

(72) Inventors: Tadashi KOBAYASHI, Toyama (JP); Terumasa SAWATO, Toyama (JP)

(73) Assignee: NACHI-FUJIKOSHI CORP., Tokyo (JP)

(21) Appl. No.: 18/424,898

(22) PCT Filed: Jun. 20, 2022
(86) PCT No.: PCT/JP2022/024455

§ 371 Date: Jan. 29, 2024

(30) Foreign Application Priority Data
Aug. 5, 2021 (JP) 2021-128822

(51) Int. Cl. B25J 9/16; B25J 15/00

(52) U.S. Cl. CPC B25J 9/1687; B25J 15/0052

(57) ABSTRACT

To provide an electronic device assembly apparatus enabling a fine displacement correction of a cable in a short time and a reliable cable connection work An electronic device assembly apparatus includes: a gripping device, a robot arm, and a robot control device. The gripping device is swingable in an arc or movable in a cable width direction The gripping device includes at least one of a suction device sucking the surface of the cable to hold the cable and gripping claws sandwiching to hold the cable; and further includes a first plate including at least one of the suction device and the gripping claws; a second plate supporting the first plate allowing the first plate to swing, and a base supporting the second plate allowing the second plate to move in the cable width direction.

### FIELD OF THE INVENTION

The present invention relates to an electronic device assembly apparatus that grips a cable used in an electronic device.

### BACKGROUND OF THE INVENTION

An electronic device assembly apparatus is used at a production site such as a plant and performs connection work for connecting a leading end of a flat soft (flexible) cable such as an FPC (Flexible Printed Circuit) or an FFC (Flexible Flat Cable) to a connector (substrate-side connector) on a circuit board or the like. The electronic device assembly apparatus includes a visual device such as a camera, a robot arm, and a controller that controls the visual device and the robot arm.

A cable is a soft elongated object having flexibility, and therefore, deforms in an unpredictable manner when it is bent or pressed. Accordingly, there is variation particularly in the position and posture of the leading end of the cable. It is difficult to recognize the leading end of the cable having such variation in the position and posture with use of the visual device of the electronic device assembly apparatus and to grip the leading end with use of the robot arm and insert the leading end into the substrate-side connector.

Also, the electronic device assembly apparatus aligns the leading end of the cable with the substrate-side connector and inserts the leading end of the cable into the substrate-side connector. At this time, a situation is conceivable in which the leading end of the cable collides with the substrate-side connector due to a slight shift in the position or posture (precise position) of the leading end of the cable and it is difficult to insert the cable into the connector.

Therefore, when it is difficult to insert the cable into the substrate-side connector in the connection work for connecting the leading end of the cable to the substrate-side connector, the electronic device assembly apparatus is required to correct the precise position of the cable that has shifted and reliably insert the leading end of the cable into the substrate-side connector.

Patent Document 1 describes an assembly system that includes a robot, a controller, and a connection jig. The controller controls a robot arm. The connection jig is fixed to a leading end of the robot arm and includes a holding device, a position correction device, and a detection device. The holding device holds a cable that is to be connected, and is movable in the front-rear direction to connect the cable to a connector. The position correction device moves the holding device in the left-right direction and further rotates the holding device in a rotation direction about a central axis extending in the up-down direction of the cable.

The detection device included in the connection jig includes a torque sensor and detects torque in the left-right direction and torque in the rotation direction when the cable comes into contact with the connector in connection work for connecting the cable to the connector. The detection device detects that an amount of movement of the holding device moved by the position correction device in the left-right direction or the rotation direction is insufficient, and outputs the detection result to the controller.

The controller controls the robot arm based on the detection result obtained from the detection device, and corrects the amount of movement of the holding device moved by the position correction device, and thus the cable is connected to the connector by the holding device. According to Patent Document 1, it is possible to precisely correct an error in alignment between the cable and the connector with this assembly system.

### PRIOR ART DOCUMENT

### Patent Document

Patent Document 1: Japanese Patent Application Laid-open No. 2019-188560

### SUMMARY OF THE INVENTION

### Problems to be Solved by the Invention

However, in the technology described in Patent Document 1, torque is detected when the cable comes into contact with the connector in the connection work for connecting the cable to the connector, and feedback control for correcting the amount of movement of the holding device based on the detected torque is repeated until the cable is connected to the connector.

Accordingly, in the technology described in Patent Document 1, alignment is performed by controlling the robot arm through the feedback control after the cable is brought into contact with the connector, and therefore, it takes time to complete the connection work. Moreover, the holding device that holds the cable is separated from a joint for moving an end effector in the left-right direction, which is a problem regarding the structure of the robot arm, and therefore, it may be difficult to accurately correct a shift in the precise position of the cable even when the robot arm is controlled.

In view of the above problems, the present invention has an object of providing an electronic device assembly apparatus that can correct a shift in the precise position of a cable in a short time and reliably perform connection work for connecting the cable.

### Means to Solve the Problem

In order to solve the above problems, a representative configuration of an electronic device assembly apparatus according to the present invention includes: a gripping device that grips a leading end of a flexible flat cable; a robot arm that moves the gripping device relative to a circuit board to which the leading end of the cable is to be connected; and a robot controller that controls operations of the gripping device and the robot arm, wherein the gripping device is swingable in an arc shape or movable in a width direction of the cable, while gripping the cable, in an in-plane direction of one surface of the cable; the gripping device includes: at least one of a suction device that holds the cable by sucking the surface of the cable and gripping claws that hold the cable by sandwiching the cable in the width direction; a first plate that includes at least one of the suction device and the gripping claws; a second plate that supports the first plate in such a manner that the first plate is swingable in an arc shape in the in-plane direction of one surface of the cable; and a base that supports the second plate in such a manner that the second plate is movable in the width direction of the cable.

When a cable is gripped by the gripping device and a leading end of the cable is inserted into a connector on a circuit board, the leading end of the cable may collide with the connector and come into partial contact therewith due to a slight shift in the position or posture (precise position) of the leading end of the cable. Note that the state in which the leading end of the cable is in partial contact with the connector is a state in which a corner of the leading end of the cable is in contact with a side wall of a hole of the connector.

However, in the above configuration, the gripping device is swingable in an arc shape or movable in a width direction of the cable, while gripping the cable, in an in-plane direction of one surface of the cable. Accordingly, when the leading end of the cable comes into partial contact with the connector, the gripping device can perform a tracing operation in which the gripping device passively swings or moves while gripping the cable as a result of being subjected to a force applied to the leading end of the cable from the connector. In this tracing operation, the gripping device moves in such a manner that the leading end of the cable enters the hole of the connector. Therefore, with the above configuration, a shift in the precise position of the leading end of the cable can be corrected in a passive manner in a short time, and connection work for connecting the cable can be reliably performed.

Moreover, in the above configuration, the first plate holds the cable with use of at least the suction device or the gripping claws, and accordingly, when the leading end of the cable comes into partial contact with the connector on the circuit board while being inserted into the connector, a force is applied to the first plate from the connector via the cable. Therefore, the first plate passively swings in an arc shape in the in-plane direction of one surface of the cable and slants with respect to the second plate. As a result of the first plate being slanted by swinging, a component of force acting in the width direction of the cable is generated. Therefore, the second plate passively moves in the width direction of the cable relative to the base. As described above, the gripping device performs the tracing operation in which the first plate passively swings and the second plate passively moves as well, and thus the gripping device can correct a shift in the precise position of the leading end of the cable and insert the leading end of the cable into the connector.

It is preferable that the gripping device further includes: a first spring that is attached to the second plate and biases the first plate toward an initial position; and a second spring that is attached to the base and biases the second plate toward an initial position.

In this case, the first plate of the gripping device does not swing in an arc relative to the second plate in the direction along the surface of the cable and is kept at its initial position by the first spring until the leading end of the cable comes into partial contact with the connector. Also, the second plate does not move in the width direction of the cable relative to the base and is kept at its initial position by the second spring. Therefore, according to the above configuration, when the leading end of the cable is accurately positioned with respect to the connector by the gripping device moved by the robot arm, the leading end of the cable does not come into partial contact with the connector, and can be reliably inserted into the connector without the precise position of the leading end of the cable being corrected.

### Effects of the Invention

According to the present invention, it is possible to provide an electronic device assembly apparatus that can correct a shift in the precise position of a cable in a short time and reliably perform connection work for connecting the cable.

### BRIEF EXPLANATION OF THE DRAWINGS

FIG. 1 is an overall configuration diagram of a robot system to which an electronic device assembly apparatus according to an embodiment of the present invention is applied.

FIG. 2 is a diagram showing a part of the electronic device assembly apparatus shown in FIG. 1.

FIG. 3 is a block diagram showing functions of the robot system shown in FIG. 1.

FIG. 4 is an enlarged view of a gripping device included in the electronic device assembly apparatus shown in FIG. 2.

FIG. 5 is a diagram showing the gripping device shown in FIG. 4 as viewed obliquely from the rear side.

FIG. 6A shows a partial contact state in which a corner of a leading end of a cable is in contact with a side wall of a hole of a connector.

FIG. 6B shows a state in which the corner of the leading end of the cable is separated from the side wall of the hole of the connector.

### EMBODIMENTS OF THE INVENTION

A preferred embodiment of the present invention is described below in detail with reference to the attached drawings. Dimensions, materials, other specific numerical values, and the like described in the embodiment are merely examples for facilitating understanding of the present invention, and do not limit the present invention unless otherwise stated. In the specification and the drawings, elements that have substantially the same function and configuration are denoted by the same reference numeral, and a redundant description of such elements is omitted. Also, illustration of elements that do not directly relate to the present invention is omitted.

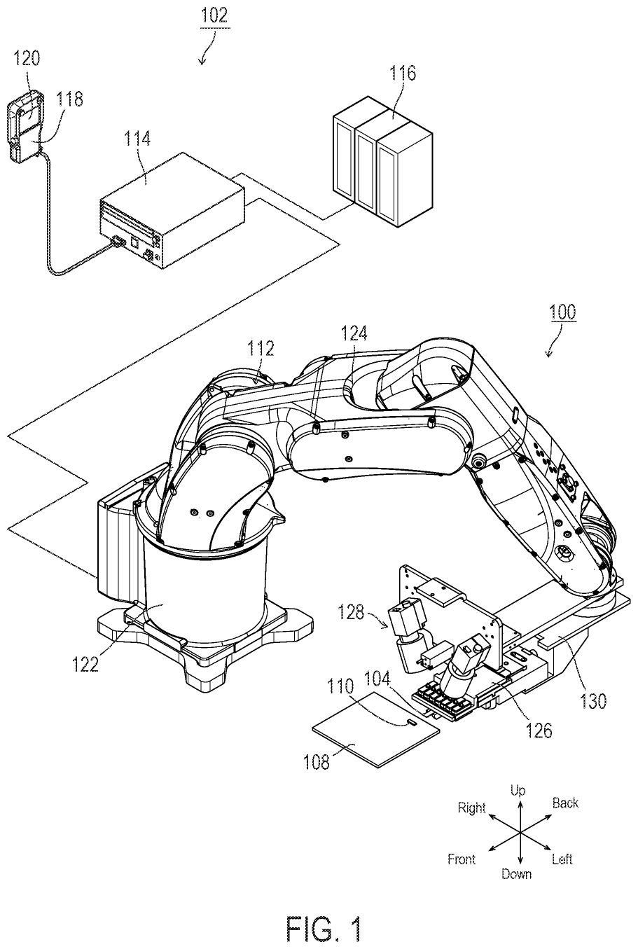

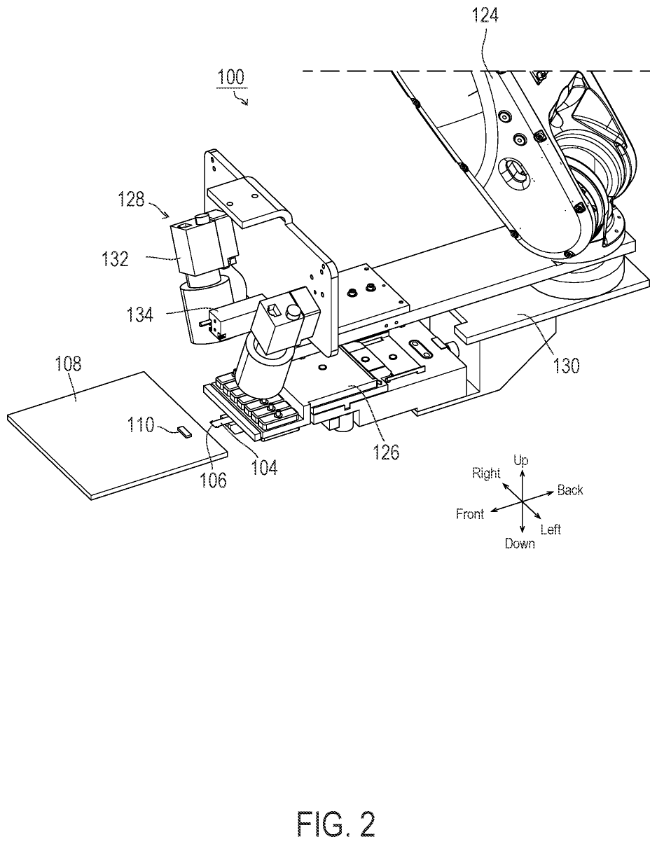

FIG. 1 is an overall configuration diagram of a robot system 102 to which an electronic device assembly apparatus 100 according to an embodiment of the present invention is applied. FIG. 2 is a diagram showing a part of the electronic device assembly apparatus 100 shown in FIG. 1. In the drawings referred to below, the front side and the back side are respectively indicated by arrows Front and Back, the left side and the right side in a width direction are respectively indicated by arrows Left and Right, and the upper side and the lower side are respectively indicated by arrows Up and Down.

The electronic device assembly apparatus 100 is used at a production site such as a plant, and automatically performs connection work for connecting (inserting) a leading end 106 of a cable 104 shown in FIG. 2 to a connector 110 on a circuit board 108, which is a connection target. The cable 104 is a flat elongated cable having flexibility such as an FPC or an FFC used in an electronic device. The cable is very flexible and includes a leading end 106 that is a free end.

In an actual production process performed at the production site, a situation is conceivable in which the leading end 106 of the cable 104 collides with the connector 110 on the circuit board 108 due to a slight shift in the position or posture (precise position) of the leading end 106 of the cable 104 when the leading end 106 is being inserted into the connector 110 in connection work for connecting the cable 104 and it is difficult to insert the cable 104 into the connector 110.

Therefore, in the electronic device assembly apparatus 100, a configuration is adopted that makes it possible to correct a shift in the precise position of the leading end 106 of the cable 104 in a short time and reliably insert the leading end 106 of the cable 104 into the connector 110 on the circuit board 108.

The electronic device assembly apparatus 100 includes a robot body 112 shown in FIG. 1 and a robot controller 114 connected to the robot body 112. The robot system 102 includes an upper-level control system 116, an input device 118, and a state notification device 120 that are connected to the robot controller 114, in addition to the electronic device assembly apparatus 100. The input device 118 is a device for inputting commands, parameters, and the like to the robot controller 114. The state notification device 120 is a device that receives and displays an operation state of the robot body 112 and a state of the connection work, which are transmitted from the robot controller 114.

The robot body 112 includes a base portion 122 shown in FIG. 1, a robot arm 124 connected to the base portion 122, a gripping device 126, and a visual device 128. The gripping device 126 is attached to a leading end 130 of the robot arm 124 as shown in FIG. 2 and grips the cable 104.

As shown in FIG. 2, the visual device 128 is an imaging device that captures images of the cable 104 and the like. The visual device 128 is attached so as to face downward toward the leading end 130 of the robot arm 124. The visual device 128 includes a camera 132, which is a visual sensor, and a lighting device 134 that lights up the circuit board 108 and the cable 104.

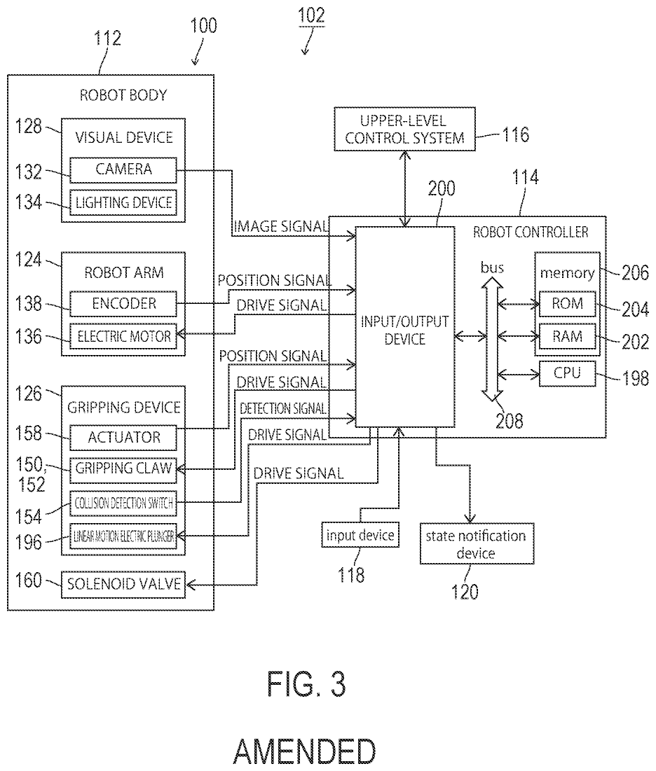

FIG. 3 is a block diagram showing functions of the robot system 102 shown in FIG. 1. The robot arm 124 is a six-axis vertical articulated robot, and includes electric motors 136, which are actuators provided at joints of the robot arm, and encoders 138 that detect positions of the joints. The encoders 138 output position signals indicating detection results of the positions of the joints to the robot controller 114. The robot controller 114 generates drive signals for driving the electric motors 136 based on the position signals received from the encoders 138. The electric motors 136 are driven by the drive signals output from the robot controller 114 and realize target operations of the robot arm 124.

With this configuration, the robot arm 124 can move the gripping device 126 attached to its leading end 130 as shown in FIG. 2 to a predetermined position. Note that the robot arm 124 is not limited to a six-axis vertical articulated robot, and may also be a vertical articulated robot in which the number of axes is not six, or a horizontal articulated robot, for example.

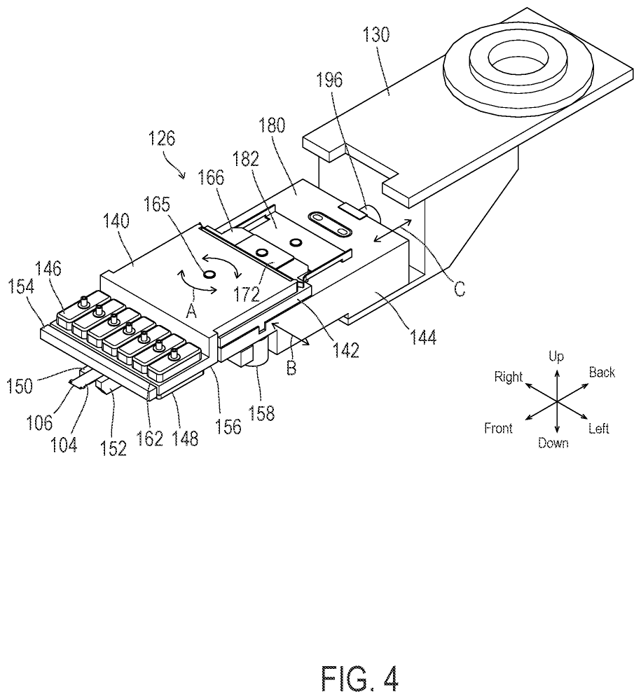

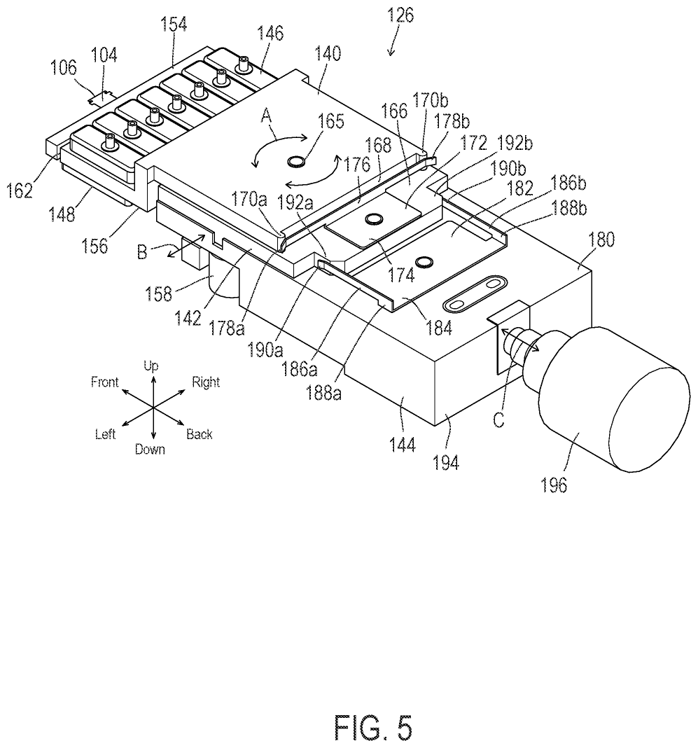

FIG. 4 is an enlarged view of the gripping device 126 included in the electronic device assembly apparatus 100 shown in FIG. 2. FIG. 5 is a diagram showing the gripping device 126 shown in FIG. 4 as viewed obliquely from the rear side. The leading end 130 of the robot arm 124 shown in FIG. 4 is omitted in FIG. 5.

The gripping device 126 includes a first plate 140, a second plate 142, and a base 144. The first plate 140 includes: a suction device 148 including a plurality of suction nozzles 146; a pair of gripping claws 150 and 152; and a collision detection switch 154. The gripping claws 150 and 152 are provided on a lower surface 156 of the first plate 140 and perform opening and closing operations so as to approach each other or separate from each other in response to being driven by an actuator 158, and thus hold the cable 104 by sandwiching the cable 104 in the width direction, or release the cable 104.

The suction device 148 is provided on the lower surface 156 of the first plate 140 and holds the cable 104 by sucking a surface (upper surface) of the cable 104 via suction holes (not shown) that are in communication with the suction nozzles 146. The suction holes are in communication with a vacuum pressure generating source such as an ejector via the suction nozzles 146, and a vacuum is created by feeding compressed air to the ejector using an operation of a solenoid valve 160 shown in FIG. 3. The solenoid valve 160 includes a plurality of on-off valves, and the number and positions of suction nozzles 146 that are used can be changed according to the width of the cable 104 to be sucked. Therefore, multiple types of cables 104 having different widths can be sucked by the same sucking device. Note that the arrangement of suction nozzles 146 that are used can be set based on position information that is obtained from an encoder (not shown) of the actuator 158 and provided to the robot in training, for example.

The solenoid valve 160 that controls the suction holes, which are in communication with the suction nozzles 146, is provided in the robot body 112 as shown in FIG. 3 and operates in response to a drive signal from the robot controller 114. However, there is no limitation to the configuration in which the solenoid valve 160 is provided in the robot body 112, and the solenoid valve 160 may be provided in an element included in the robot system 102.

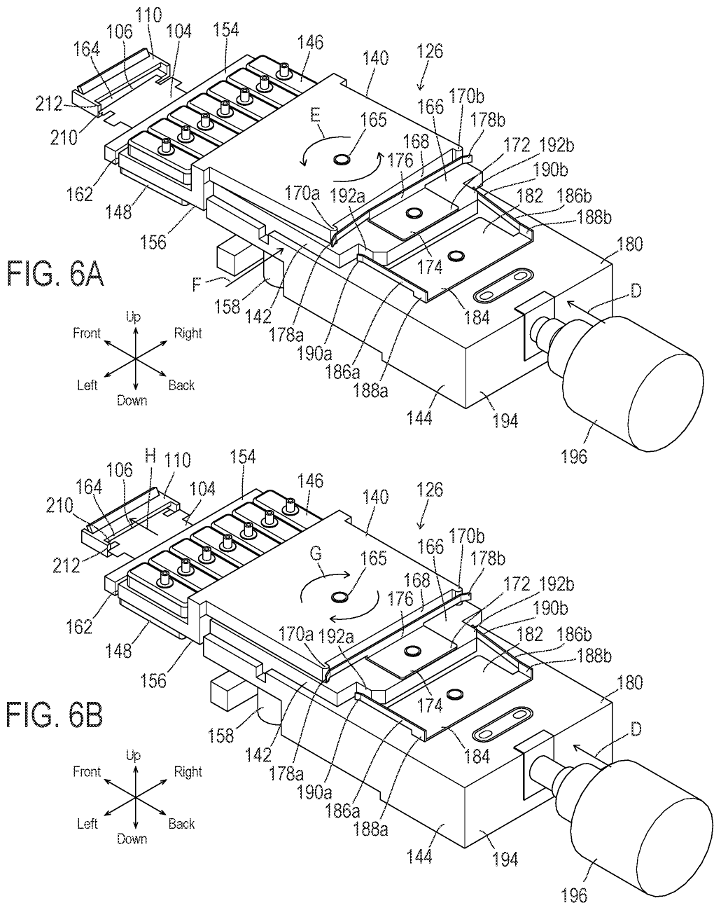

The collision detection switch 154 is provided on a front surface 162 of the first plate 140 as shown in FIG. 4. The collision detection switch 154 detects an abnormality such as collision between the leading end 106 of the cable 104 and a hole 164 (see FIG. 6A) of the connector 110 on the circuit board 108 in the connection work for connecting the cable 104, and outputs a detection signal to the robot controller 114. The robot controller 114 can determine that an abnormality has occurred in the connection work for connecting the cable 104 based on the detection signal received from the collision detection switch 154 shown in FIG. 3.

The second plate 142 is located under the first plate 140 and supports the first plate 140 in such a manner that the first plate 140 is swingable in a direction along a surface of the cable 104 in an arc about a central shaft 165 extending in an up-down direction (see arrows A in the drawings). As shown in FIG. 5, the second plate 142 includes a rear extended portion 166. The rear extended portion 166 is a portion extending rearward past a rear surface 168 of the first plate 140 in the state where the second plate 142 is located under the first plate 140. Also, protrusions 170a and 170b protruding rearward are formed at two opposite ends of the rear surface 168 of the first plate 140.

A first spring 172 is attached to an upper surface of the rear extended portion 166 of the second plate 142. The first spring 172 is a leaf spring and includes a bottom 174 that is attached to the upper surface of the rear extended portion 166, and a wall 176. The wall 176 is a portion that is bent upward from the bottom 174 and extends in a width direction of the cable 104 as shown in FIG. 5, and both ends 178a and 178b of the wall 176 in the width direction respectively come into contact with the protrusions 170a and 170b of the rear surface 168 of the first plate 140.

The ends 178a and 178b of the wall 174 of the first spring 172 come into contact with the protrusions 170a and 170b of the first plate 140, and thus the first spring 172 biases the first plate 140 toward its initial position and maintains the position of the first plate 140 to prevent the precise position of the leading 106 of the cable 104 from shifting due to the leading end 106 swinging in an arc in a direction along the surface of the cable 104.

As shown in FIG. 5, the base 144 is located under the second plate 142 and supports the second plate 142 in such a manner that the second plate 142 is movable in the width direction of the cable 104 (see the arrow B in the drawings). A second spring 182 is attached to an upper surface 180 of the base 144.

The second spring 182 is a leaf spring and includes a bottom 184 that is attached to the upper surface 180 of the base 144 and two arms 186a and 186b. Rear ends 188a and 188b of the arms 186a and 186b are bent upward from the bottom 184, and the arms 186a and 186b extend forward toward the rear extended portion 166 of the second plate 142 in a cantilever manner. Leading ends 190a and 190b of the arms 186a and 186b come into contact with side walls 192a and 192b of the rear extended portion 166 of the second plate 142 from outer sides in the width direction.

With this configuration, the second spring 182 biases the second plate 142 toward its initial position and maintains the position of the second plate 142 to prevent the precise position of the leading 106 of the cable 104 from shifting due to the leading end 106 moving in the width direction.

As shown in FIG. 5, a linear motion electric plunger 196 that is driven by a drive signal (see FIG. 3) output from the robot controller 114 is attached to a rear surface 194 of the base 144. The linear motion electric plunger 196 is also attached to the leading end 130 of the robot arm 124 shown in FIG. 4. With this configuration, the linear motion electric plunger 196 can move the base 144 in the front-rear direction (see the arrow C in the drawings) relative to the leading end 130 of the robot arm 124 in response to a drive signal output from the robot controller 114. As a result of the base 144 moving in the front-rear direction, the entire gripping device 126 moves in the front-rear direction. Accordingly, the gripping device 126 can move the leading end 106 of the cable 104 held by the gripping claws 150 and 152 of the first plate 140 toward or away from the connector 110 on the circuit board 108 when the linear motion electric plunger 196 is driven.

Here, the elements shown in FIG. 3 will be described in detail. The camera 132 and the lighting device 134 included in the visual device 128 are attached to the leading end 130 of the robot arm 124 (see FIG. 1), but there is no limitation to this configuration, and the camera and the lighting device may be provided at a position other than the robot body 112 so long as an overhead image of a work area of the connection work can be obtained. At least one camera 132 needs to be provided, and it is preferable to provide two or more cameras in order to enhance imaging precision. The camera 132 may obtain color images or monochrome images.

In the case where the camera 132 is a monocular camera, three-dimensional imaging information can be estimated with use of known SLAM (Simultaneous Localization and Mapping) technology. However, in this case, the camera 132 needs to be moved while taking images. Note that, in principle, the camera 132 can obtain only a relative value of distance, but when positional information of the camera 132 can be obtained from the robot controller 114, it is possible to obtain positional information in a robot coordinate system.

In the case where the camera 132 is a stereo camera, positional information can be obtained from parallax information obtained through known stereo matching. In the case where the camera 132 is a multi-view camera, the principle is the same as that of the stereo camera, and parallax images taken from various directions can be obtained, and therefore, occlusion is unlikely to occur. In the case where the camera 132 is a TOF (Time of Flight) camera, positional information can be obtained based on the time it takes to receive light reflected from a subject after the light is emitted toward the subject. In the case where the camera 132 uses emitted light, positional information can be obtained by performing known pattern projection (projection of a stripe pattern or a random dot pattern).

The lighting device 134 is installed in a surrounding region of a lens of the camera 132 for capturing images, for example, and lights up the cable 104 to be gripped by the gripping device 126 and the connector 110 on the circuit board 108 to which the cable is to be connected. However, there is no limitation to this configuration, and the lighting device may also emit pattern light when measuring a distance.

As shown in FIG. 3, the robot controller 114 includes a CPU 198, an input/output device 200 for inputting and outputting signals, and a memory 206 including a RAM 202 and a ROM 204. The CPU 198, the input/output device 200, and the memory 206 are connected to each other via a bus 208 in such a manner that signals can be transmitted therebetween.

The CPU 198 functions as an arithmetic processing device, accesses the memory 206, and reads out and executes various programs stored in the RAM 202, the ROM 204, an external storage device, or the like. The RAM 202 and the ROM 204 are computer-readable recording mediums including programs recorded thereon for controlling the robot body 112. For example, a program and a device constant used by the CPU 198 are stored in the ROM 204. For example, a program used by the CPU 198 and a variable that varies successively during execution of the program are temporarily stored in the RAM 202. As described above, the robot controller 114 can control the robot body 112 and the gripping device 126 by executing various programs and cause the robot body 112 and the gripping device 126 to execute various functions.

The input/output device 200 of the robot controller 114 includes a communication device, a D/A converter, a motor drive circuit, an A/D converter, and the like, and connects the robot controller 114 to an external device, the electric motors 136, the actuator 158, and various sensors such as the encoders 138 via an interface. Examples of specific communication methods used by the communication device may include data communication in accordance with serial communication standards such as RS232C/485 or USB standards, EtherNET (registered trademark), which is a common network protocol, and EtherCAT (registered trademark) and EtherNet/IP (registered trademark), which are used as industrial network protocols.

The robot controller 114 may also be connected via the input/output device 200 to a storage device for storing data or a drive device that is a reader-writer for recording mediums. The robot controller 114 is not limited to a controller in which dedicated hardware is incorporated, and may also be a general-purpose personal computer that can execute various functions when various programs are installed, for example.

Note that the robot controller 114 controls all of the robot arm 124, the gripping device 126, and the visual device 128, but there is no limitation to this configuration. For example, the robot controller 114 may be configured as a group of a plurality of controller s that respectively control the robot arm 124, the gripping device 126, and the visual device 128, and the plurality of controller s may be connected to each other wirelessly or by cable. Furthermore, the robot controller 114 is provided outside the robot body 112 in the electronic device assembly apparatus 100, but there is no limitation to this configuration, and the robot controller 114 may also be provided inside the robot body 112.

The input device 118 includes an operation means to be operated by a user, such as a keyboard, a mouse, a touch panel, a button, a switch, a lever, a pedal, a remote control means that uses infrared rays or other radio waves, or a personal computer or teaching pendant including these devices. The user who performs the connection work uses the input device 118 to perform input and setting. Note that a program that causes the robot body 112 to execute various functions may be created with use of the input device 118. The program may be written in a low level language such as a machine language or a high level language such as a robot language.

The state notification device 120 receives information regarding an operation state of the robot body 112 and information regarding a state of the leading end 106 of the cable 104 inserted into the connector 110 on the circuit board 108 from the robot controller 114 and displays the information to enable the user to recognize the information visually and intuitively. The state notification device 120 may be a display device such as a liquid crystal panel, a teaching pendant, or a lighting lamp, or a notification device that gives notifications regarding information with use of an alert sound or audio. For example, the state notification device 120 may be set so as to issue an alert when the connection work for inserting the leading end 106 of the cable 104 into the connector 110 has failed. Alternatively, a screen of a personal computer or a teaching pendant may serve as the state notification device 120. The state notification device 120 may include an application for performing input and notification of states.

The upper-level control system 116 is constituted by, for example, a sequencer (PLC), a monitoring and control system (SCADA), a process computer (PROCOM), a personal computer, various servers, or a combination thereof, and connected to the robot controller 114 wirelessly or by cable. The upper-level control system 116 outputs instructions based on operation states of devices that constitute a production line including the robot controller 114, and comprehensively controls the production line.

The upper-level control system 116 can also be used to monitor a defect rate or a cycle time or inspect products by receiving and collecting the time it takes to complete the connection work, a state after the connection work is complete, or the like from the robot controller 114. Furthermore, the upper-level control system 116 may obtain information regarding a state of the operation for gripping the cable 104 with the gripping device 126 of the robot body 112 from the robot controller 114 to cause the robot arm 124 to return to a home position or stop each device.

Next, operations of the electronic device assembly apparatus 100 will be described. FIG. 6A shows a partial contact state in which a corner of the leading end of the cable is in contact with a side wall of the hole of the connector, and FIG. 6B shows a state in which the corner of the leading end of the cable is separated from the side wall of the hole of the connector. In the drawings, for the sake of convenience, the width of the cable 104 is enlarged and the connector 110 into which the leading end 106 of the cable 104 is inserted is also enlarged.

Here, the electronic device assembly apparatus 100 is in a state in which a drive signal has been output by the CPU 198 to the robot arm 124 to cause the robot arm 124 to operate and move the gripping device 126 to position the leading end 106 of the cable 104 with respect to the connector 110. The CPU 198 outputs a drive signal to the linear motion electric plunger 196 to cause the linear motion electric plunger 196 to operate and press the base 144 forward as shown by the arrow D in FIG. 6A so that the leading end 106 of the cable 104 held by the gripping claws 150 and 152 (see FIG. 4) of the first plate 140 approach the connector 110.

However, as shown in FIG. 6A, a corner 210 of the leading end 106 of the cable 104 is in partial contact with a side wall 212 of the hole 164 of the connector 110 due to a shift in the precise position of the leading end 106 of the cable 104.

With such a situation in mind, the gripping device 126 is configured to be swingable in an arc in a direction along a surface of the cable 104 and movable in the width direction of the cable 104 while gripping the cable 104. That is, the first plate 140 of the gripping device 126 holds the cable with use of the suction device 148 and the gripping claws 150 and 152. Accordingly, a force is applied to the first plate 140 from the side wall 212 of the hole 164 of the connector 110 via the corner 210 of the leading end 106 of the cable 104.

Therefore, the first plate 140 passively swings in an arc in a direction along the surface of the cable 104 as shown by arrows E in FIG. 6A and slants with respect to the second plate 142. As a result of the first plate 140 being slanted by swinging, a component of force acting in the width direction of the cable 104 is generated.

Next, the second plate 142 passively moves in the width direction of the cable 104 relative to the base 180 as shown by the arrow F in FIG. 6A due to the component of force acting in the width direction of the cable 104 being applied to the second plate 142.

Therefore, the corner 210 of the leading end 106 of the cable 104 separates from the side wall 212 of the hole 164 of the connector 110 as shown in FIG. 6B. Then, the first plate 140 swings as shown by arrows G in FIG. 6B and is kept at its initial position by being biased by the first spring 172. On the other hand, the second plate 142 is kept at the position to which the second plate has moved in the width direction of the cable 104. Thus, the shift in the precise position of the leading end 106 of the cable 104 is corrected, and the leading end 106 enters the hole 164 of the connector 110.

The base 180 is continuously pressed forward by the linear motion electric plunger 196 at a constant speed, for example, and accordingly, the leading end 106 of the cable 104, for which the shift in the precise position has been corrected, is reliably inserted into the hole 164 of the connector 110 as shown by the arrow H in FIG. 6B.

As described above, in the robot system 102 to which the electronic device assembly apparatus 100 is applied, when the leading end 106 of the cable 104 comes into partial contact with the connector 110, the gripping device 126 performs a tracing operation in which the first plate 140 passively swings and the second plate 142 passively moves as well. Thus, the gripping device 126 moves in such a manner that the leading end 106 of the cable 104 enters the hole 164 of the connector 110, and therefore, the electronic device assembly apparatus 100 can correct a shift in the precise position of the leading end 106 of the cable 104 in a passive manner in a short time, and reliably perform the connection work for connecting the cable 104 by inserting the leading end 106 of the cable 104 into the connector 110.

Moreover, the first plate 140 of the gripping device 126 does not swing in an arc relative to the second plate 142 in a direction along the surface of the cable 104 and is kept at its initial position by the first spring 172 until the leading end 106 of the cable 104 comes into partial contact with the connector 110. Also, the second plate 142 does not move in the width direction of the cable 104 relative to the base 144 and is kept at its initial position by the second spring 182 until the leading end 106 of the cable 104 comes into partial contact with the connector 110.

Therefore, when the leading end 106 of the cable 104 is accurately positioned with respect to the connector 110 by the gripping device 126 moved by the robot arm 124, the leading end 106 of the cable 104 does not come into partial contact with the connector 110, and the electronic device assembly apparatus 100 can reliably insert the leading end 106 of the cable 104 into the connector 110 without correcting the precise position of the leading end 106 of the cable 104.

Furthermore, the mechanism that enables the gripping device 126 to swing in an arc in a direction along the surface of the cable 104 and move in the width direction of the cable 104 while gripping the cable 104 is provided at a position in the gripping device 126 that is close to the leading end 106 of the cable 104, and therefore, it is easy to control precision in correcting a shift in the precise position of the cable 104.

Note that, as long as the gripping device 126 can hold the cable 104 reliably in the connection work for connecting the cable 104, there is no limitation to the configuration in which the gripping device 126 includes the suction device 148 and the gripping claws 150 and 152, and a configuration is also possible in which the gripping device 126 includes at least one of the suction device 148 and the gripping claws 150 and 152.

The following configuration may also be adopted to detect that the leading end 106 of the cable 104 has been inserted into the hole 164 of the connector 110 (see FIG. 6A) on the circuit board 108. That is, it is possible to adopt a configuration in which a spring component is provided between the linear motion electric plunger 196 and the base 144 of the gripping device 126, and a linear encoder (distance sensor) for measuring displacement of the spring component is attached to check if the position of the spring component has changed by a prescribed amount by seeing the position after an operation, for example. Alternatively, it is also possible to adopt a configuration in which a limit is set for a thrusting force of the linear motion electric plunger 196 in the gripping device 126 so as not to apply a force greater than a predetermined magnitude, and a linear encoder (distance sensor) is attached to the linear motion electric plunger 196 to check if the position of the linear motion electric plunger has changed by a prescribed amount by seeing the position after an operation, for example. By adopting these configurations for the electronic device assembly apparatus 100, it is possible to detect whether or not the connection work for connecting the cable 104 has been completed.

While a preferred embodiment of the present invention has been described with reference to the attached drawings, it goes without saying that the present invention is not limited to the embodiment. It is clear that those skilled in the art will be able to arrive at various changes and modifications within the scope of the claims, and those changes and modifications are understood to naturally fall within the technical scope of the present invention.

This application is based upon and claims the benefit of priority from the prior Japanese Patent Application No. 2021-128822, filed on Aug. 5, 2021, the above contents are cited in the specification, claims, and drawings of the present application.

### INDUSTRIAL APPLICABILITY

The present invention can be used as an electronic device assembly apparatus that grips a cable used in an electronic device.

### INDEX TO THE REFERENCE NUMERALS

100 . . . electronic device assembly apparatus; 102 . . . robot system; 104 cable; 106 . . . leading end of cable; 108 . . . circuit board; 110 . . . connector; 112 . . . robot body; 114 . . . robot controller; 116 . . . upper-level control system; 118 . . . input device; 120 . . . state notification device; 122 . . . base portion; 124 . . . robot arm; 126 . . . gripping device; 128 . . . visual device; 130 . . . leading end of robot arm; 132 . . . camera; 134 . . . lighting device; 136 . . . electric motor; 138 . . . encoder; 140 . . . first plate; 142 . . . second plate; 144 . . . base; 146 . . . suction nozzle; 148 . . . suction device; 150, 152 . . . gripping claw; 154 . . . collision detection switch; 156 . . . lower surface of first plate; 158 . . . actuator; 160 . . . solenoid valve; 162 . . . front surface of first plate; 164 . . . hole of connector; 166 . . . rear extended portion; 168 . . . rear surface of first plate; 170a, 170b . . . protrusion; 172 . . . first spring; 174 . . . bottom of first spring; 176 . . . wall of first spring; 178a, 178b . . . end of wall; 180 . . . upper surface of base; 182 . . . second spring; 184 . . . bottom of second spring; 186a, 186b . . . arm; 188a, 188b . . . rear end of arm; 190a, 190b . . . leading end of arm; 192a, 192b . . . side wall of rear extended portion; 194 . . . rear surface of base; 196 . . . linear motion electric plunger; 198. . . . CPU; 200 input/output device; 202. . . . RAM; 204. . . . ROM; 206 . . . memory; 208 . . . bus; 210 . . . corner of leading end of cable; 212 . . . side wall of hole of connector

1. An electronic device assembly apparatus comprising:
a gripping device that grips a leading end of a flexible flat cable;
a robot arm that moves the gripping device relative to a circuit board to which the leading end of the cable is to be connected; and
a robot controller that controls operations of the gripping device and the robot arm,
wherein the gripping device, while gripping the cable, swings freely in an arc shape or moves freely in a width direction of the cable in an in-plane direction of one surface of the cable, and
the gripping device includes:
at least one of a suction device that holds the cable by sucking the surface of the cable and gripping claws that hold the cable by sandwiching the cable in the width direction;
a first plate that includes at least one of the suction device and the gripping claws;
a second plate that supports the first plate in such a manner that the first plate is swingable in an arc in the direction along the surface of the cable; and
a base that supports the second plate in such a manner that the second plate is movable in the width direction of the cable.

2. The electronic device assembly apparatus according to claim 1,
wherein the gripping device further includes:
a first spring that is attached to the second plate and biases the first plate toward an initial position; and
a second spring that is attached to the base and biases the second plate toward an initial position.
